(19) United States
(12) Patent Application Publication
(10) Pub. No.: US 2011/0168861 A1
(43) Pub. Date: Jul. 14, 2011

(54) Guitar holding/mounting device

(75) Inventor: Stephen Benart Simon, Carlsbad, CA (US)

(73) Assignee: Stephen Benard Simon, Carlsbad, CA (US)

(21) Appl. No.: 12/657,009

(22) Filed: Jan. 13, 2010

(51) Int. Cl. F16M 13/02

(52) U.S. Cl. 248/309.4

(57) ABSTRACT

The invention, a guitar holding/mounting device, was created as an application to hold, mount or display guitars in a retail, home or recording studio environments as an improvement over current products and or methods in which guitars are hung by the neck and head stock by a “U” shaped holder, which has shown a propensity to detune, damage guitar finishes and place undue stress on the instrument over all, causing depreciation in value and additional maintenance.

The guitar holding/mounting device is designed to solve current shortcomings of existing products by holding and securing the instrument in place by means of “nesting” the body onto the mount through use of a high strength Neodymium magnet located at the top of the invention positioned behind the guitar body as opposed to hanging guitar by the neck and or head stock to hang or mount the guitar.

The claimed guitar holding/mounting device is used for displaying guitars and could be mounted on slat wall or any other type of wall surface.

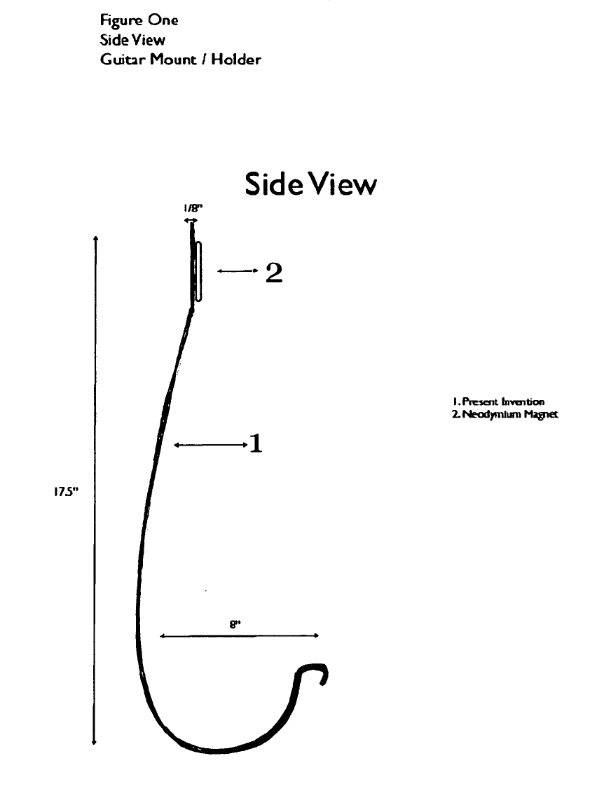

FIG. 1 is a right side view of my guitar holding/mounting device showing my design;

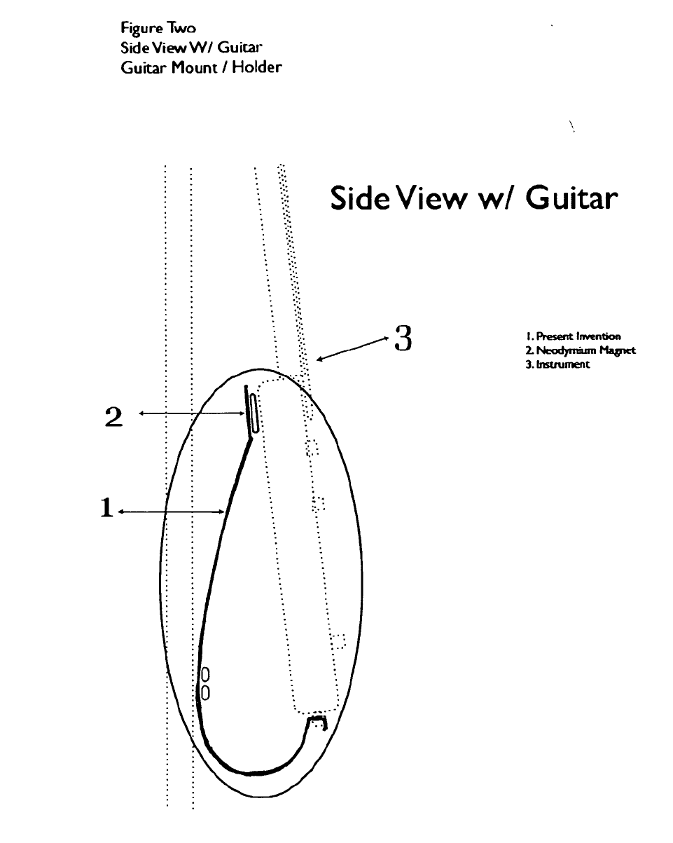

FIG. 2 is a right side view with guitar thereof, the left side being a mirror image;

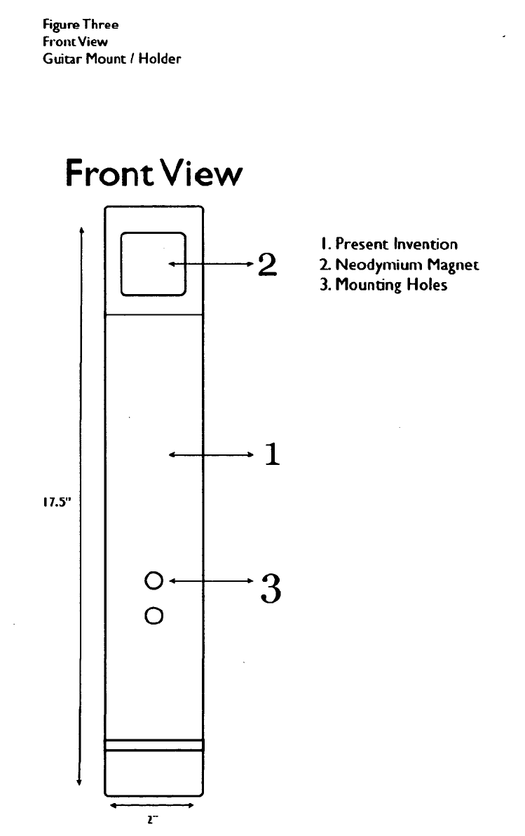

FIG. 3 is a front view thereof;

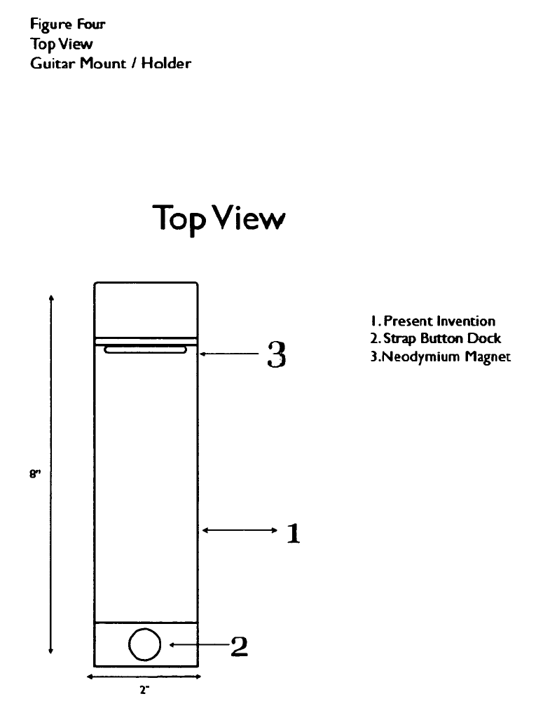

FIG. 4 is a top view thereof.

The broken line drawing in FIG. 2 is meant to illustrate the intended placement of a guitar in the holding/mounting device, and is not part of the design sought to be patented.

The Neodymium magnet, denoted by the Arabic numeral “2” on FIGS. 1 through 4, is an essential feature of the design of the guitar holding/mounting device.

I claim:

1. The ornamental design for a guitar holding/mounting device as shown.
General Statement
A Guitar holding/mounting device comprising: A formed steel or metal guitar holder, shaped in dimensions which allow device to hold and secure instrument by its body and parts attached to it's body—which holds or displays the instrument without “hanging” instrument by the neck and or headstock.
Essential elements include:
1. Physical Shape—The shape and design are integral to the function of the guitar holding/mounting device. Designed and engineered to specific angles, shape and size for specific function of holding or mounting guitars in the manner intended, resulting in superior function, durability, performance and quality.
2. Neodymium Magnets placed in specific positions to “draw”, hold and secure metal components of guitar to the holding/mounting device
3. Strap Button Dock—A circular opening located on device to accept guitar strap “button” or “lock” allowing guitar or instrument to securely “nest” and or secure its location on the holder
